(19) United States
(12) Patent Application Publication
(10) Pub. No.: US 2026/0340364 A1
(43) Pub. Date: Oct. 29, 2026

(54) METHOD FOR GENERATING MULTIMODAL CONTENT, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Daizhen SUN, Beijing (CN); Ying WANG, Beijing (CN); Hao ZHONG, Beijing (CN); Yu SUN, Beijing (CN); Yuhang LIANG, Beijing (CN); Qing LIU, Beijing (CN); Tong ZHANG, Beijing (CN); Rensong CHEN, Beijing (CN); Tao WU, Beijing (CN); Manting WANG, Beijing (CN); Yan WANG, Beijing (CN); Yu ZHANG, Beijing (CN); Guozhi HAN, Beijing (CN)

(73) Assignee: BEIJING BAIDU NETCOM SCIENCE TECHNOLOGY CO., LTD., Beijing (CN)

(21) Appl. No.: 19/703,797

(22) Filed: Jun. 10, 2026

(30) Foreign Application Priority Data
Nov. 13, 2025 (CN) 202511666964.4

(51) Int. Cl. G06N 3/0475

(52) U.S. Cl. CPC G06N 3/0475

(57) ABSTRACT

Provided is a method for generating multimodal content, an electronic device and a storage medium, relating to the field of artificial intelligence technology and specifically to the fields of natural language processing, computer vision, human-computer interaction, deep learning and other technologies, and can be applied to scenarios such as intelligent document generation. The method includes: receiving a user input, the user input comprising material uploaded by a user and a user instruction; analyzing the user input to determine the user's generation intent; outputting at least one content generation option based on the generation intent; and generating multimodal content based at least on the generation intent and the material in response to the user's selection of a target content generation option.

### CROSS-REFERENCE TO RELATED APPLICATIONS

The present application claims priority to Chinese Patent Application No. CN202511666964.4, filed with the China National Intellectual Property Administration on Nov. 13, 2025, the disclosure of which is hereby incorporated herein by reference in its entirety.

### TECHNICAL FIELD

The present disclosure relates to the field of artificial intelligence technology and specifically to the fields of natural language processing, computer vision, human-computer interaction, deep learning and other technologies, and can be applied to scenarios such as intelligent document generation. Specifically, the present disclosure relates to a method and an apparatus for generating multimodal content, an intelligent agent and an electronic device.

### BACKGROUND

Currently, the content generation tools based on artificial intelligence generally adopt a linear processing mode of “input-output”. After a user submits a text instruction and materials, the system directly calls the model to generate a result. However, this “input-output” black box mode results in a discrepancy between the user's intent and the generated result, leading to repeated trial and error, low production efficiency and poor process controllability.

### SUMMARY

The present disclosure provides a method and an apparatus for generating multimodal content, an intelligent agent and an electronic device.

According to a first aspect of the present disclosure, provided is a method for generating multimodal content, including: receiving a user input, where the user input includes material uploaded by a user and a user instruction; analyzing the user input to determine the user's generation intent; outputting at least one content generation option based on the generation intent; and generating multimodal content based at least on the generation intent and the material in response to the user's selection of a target content generation option.

According to a second aspect of the present disclosure, provided is an apparatus for generating multimodal content, including: an information receiving module configured to receive a user input, where the user input includes material uploaded by a user and a user instruction; an intent determining module configured to analyze the user input to determine the user's generation intent; an option providing module configured to output at least one content generation option based on the generation intent; and a content generating module configured to generate multimodal content based at least on the generation intent and the material in response to the user's selection of a target content generation option.

According to a third aspect of the present disclosure, provided is an intelligent agent, including: an input module configured to receive input information; a processing module configured to perform steps in the method for generating multimodal content of the first aspect based on the input information, to determine a target task and execute the target task to obtain output information; and an output module configured to output the output information obtained by the processing module.

According to a fourth aspect of the present disclosure, provided is an electronic device, including: at least one processor; and a memory connected in communication with the at least one processor; where the memory stores an instruction executable by the at least one processor, and the instruction is executed by the at least one processor to enable the at least one processor to execute the method according to any one of the embodiments of the present disclosure.

According to a fifth aspect of the present disclosure, provided is a non-transitory computer-readable storage medium storing a computer instruction thereon, and the computer instruction is used to cause a computer to execute the method according to any one of the embodiments of the present disclosure.

According to a sixth aspect of the present disclosure, provided is a computer program product including a computer program, and the computer program implements the method according to any one of the embodiments of the present disclosure, when executed by a processor.

Using the solution of the present disclosure, the user intent is accurately recognized by comprehensively analyzing the material and user instruction, and the content generation options are dynamically provided based on the recognition result, allowing the user to participate in key decisions through selection operations, thereby avoiding understanding deviations from the source, and ultimately improving the controllability of the generation process while significantly improving the content generation efficiency and the accuracy of the generated content.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flowchart of a method for generating multimodal content according to an embodiment of the present disclosure;

FIG. 2 is a schematic diagram of doodling on a canvas interface according to an embodiment of the present disclosure;

FIG. 3 is a schematic diagram of a triggering and processing flow of a multimodal content generation task according to an embodiment of the present disclosure;

FIG. 4 is a schematic diagram of an asynchronous callback and result processing flow of the generation task according to an embodiment of the present disclosure;

FIG. 5 is a schematic diagram of a triggering and execution process of an intelligent generation function based on image materials according to an embodiment of the present disclosure;

FIG. 6 is a schematic diagram of a video generation and intelligent optimization process of first and last frames according to an embodiment of the present disclosure;

FIG. 7 is a structural schematic diagram of an apparatus for generating multimodal content according to an embodiment of the present disclosure;

FIG. 8 is a structural schematic diagram of an intelligent agent according to an embodiment of the present disclosure;

FIG. 9 is a schematic diagram of a scenario of the method for generating multimodal content according to an embodiment of the present disclosure; and

FIG. 10 is a structural diagram of an electronic device for implementing the method for generating multimodal content in the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

Before the technical solutions of the embodiments of the present disclosure are introduced, the technical terms that may be used in the present disclosure are further explained:

Doodling refers to the freehand drawing operation carried out by users on the canvas interface with specific materials through input devices such as stylus, mouse or touchscreen. These drawing traces, as unstructured visual input, are captured, parsed, and given explicit semantics by the system in real time, and then transformed into executable operation instructions.

In related technologies, after a user submits a text instruction and materials, the system directly calls the model to generate a result. This mode has significant drawbacks: firstly, the system only performs superficial processing on the input content, and lacks in-depth analysis and strategy matching of the user's true generation intent, resulting in a serious deviation between the output result and expectation; secondly, the process lacks the necessary user confirmation and configuration steps, making the generation process uncontrollable and forcing the user to repeatedly try and fail to approximate the ideal effect; and finally, the system lacks an effective status feedback mechanism, and the front-end interface cannot reflect the back-end generation progress in real time, resulting in the fragmented user experience. These problems collectively lead to the technical predicament of low content generation efficiency, unstable quality and poor user experience.

In order to at least partially solve one or more of the above problems and other potential problems, the present disclosure proposes a method for generating multimodal content. By introducing an intent-driven interaction mechanism and real-time status feedback, this method enhances the controllability of the content generation process, improves the overall execution efficiency from instruction input to result output, and increases the matching degree between output content and expected goal as well as the final generation quality through accurate understanding of user intent and process intervention.

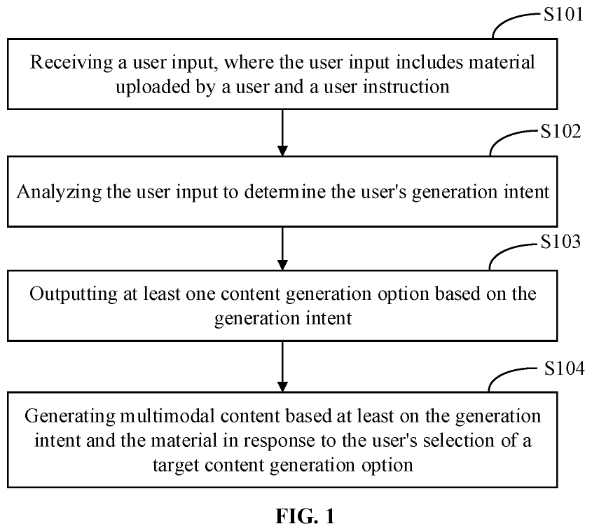

An embodiment of the present disclosure provides a method for generating multimodal content. FIG. 1 is a schematic flowchart of the method for generating multimodal content according to the embodiment of the present disclosure. This method for generating multimodal content can be applied to an apparatus for generating multimodal content. The apparatus for generating multimodal content is located in an electronic device. This electronic device includes but is not limited to a fixed device and/or a mobile device. For example, the fixed device includes but is not limited to a server, and the server may be a cloud server or an ordinary server. For example, the mobile device includes but is not limited to a mobile phone, a tablet, a vehicle-carried terminal, etc. In some possible implementations, the method for generating multimodal content may also be implemented by the processor calling a computer-readable instruction stored in the memory. As shown in FIG. 1, the method for generating multimodal content includes:
S101: receiving a user input, where the user input includes material uploaded by a user and a user instruction.
S102: analyzing the user input to determine the user's generation intent.
S103: outputting at least one content generation option based on the generation intent.
S104: generating multimodal content based at least on the generation intent and the material in response to the user's selection of a target content generation option.

In the embodiment of the present disclosure, the material is basic data for content generation, such as images, video clips, texts, data tables, etc.

In the embodiment of the present disclosure, the user input refers to all information and instructions submitted to the system by the user in any way (clicking, dragging, doodling, typing, uploading files, etc.). For example, the user uploads an image to the interactive interface and doodles a red circle on the image, and simultaneously enters a text instruction “make this part red”.

In the embodiment of the present disclosure, the user instruction is an operation or text command issued by the user to express the generation requirement, and may be a doodling or box selection operation on the material on a canvas or may be natural language text entered in a dialog box.

In some implementations, the system listens for and captures user interaction events (including file upload, drawing on material, selection operation and text input) through different interactive areas (such as canvas and dialog boxes) in the Graphical User Interface (GUI), and integrates these diverse input information into a complete processing request, thus providing a more natural and accurate way to express intent, reducing the user's operation and communication costs, and laying the foundation for subsequent accurate intent recognition.

In the embodiment of the present disclosure, the generation intent is a result of the system's understanding of the user's requirement. For example, combining an image uploaded by the user with a text instruction “anime style”, the system recognizes the generation intent as “image-to-image style conversion”; if the user selects multiple images, the system may recognize the generation intent as “multi-image-to-video”.

In some implementations, the system calls the intent recognition module to perform multimodal comprehensive analysis on the type and quantity of the material and the semantics of the user instruction. Through a pre-trained deep learning model or rule strategy library, the analysis result is mapped to a predefined generation strategy, thereby outputting a structured generation intent. In this way, the ambiguous and diverse user inputs are transformed into clear and executable generation tasks, fundamentally avoiding the problem of unexpected generation results due to deviations in intent understanding, and providing a core guarantee for achieving accurate generation.

In the embodiment of the present disclosure, the content generation option is a specific execution path or configuration recommended to the user by the system based on the generation intent. For example, when the generation intent is “text-to-image”, the system may provide options such as “realistic style” and “cartoon style”; when the generation intent is “multi-image-to-video”, the option may be “slideshow” or “dynamic scene transition”.

In some implementations, the system retrieves one or more associated feasible generation paths from a pre-configured strategy library according to the determined generation intent, and presents these paths on the user interface in the form of button, list or card for the user to select. In this way, control is returned to the user before the final generation, enabling the user to confirm and select at key decision points, effectively eliminating the uncontrollability of the traditional “black box” model and improving the predictability of the generated result.

In the embodiment of the present disclosure, the target content generation option is a content generation option selected by the user from multiple options provided by the system. The multimodal content is the final generated result, and the form thereof may be the same as or different from the input modality, for example, a video generated from text and images, or a new image generated after modification according to the doodling instruction.

In some implementations, the system packages the user's final selection (target option), the identified generation intent and the original material into a structured configuration task, and then calls a background intelligent agent (such as an Artificial Intelligence (AI) model) to schedule computing resources to execute the generation task and finally output the result. In this way, the backend intelligent agent is driven by a standardized process that integrates explicit user choices, ensuring the efficient and reliable execution of the generation task, and ultimately outputting the high-quality multimodal content meeting the user expectation.

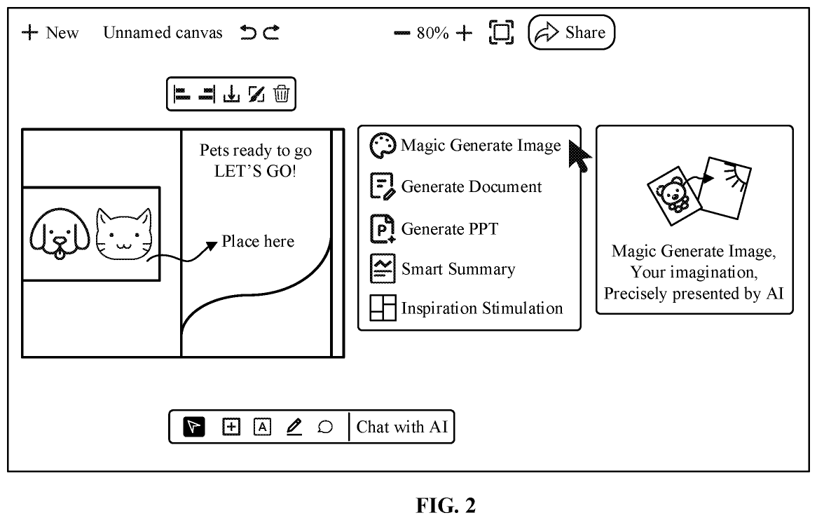

FIG. 2 shows a schematic diagram of doodling on the canvas interface. As shown in FIG. 2, the user first uploads two images to the canvas interface and doodles an arrow and the text “Place here”. After selecting these contents, the interface will present option guidance: Magic Generate Image, Generate Document, Generate PowerPoint (PPT), Smart Summary, and Inspiration Stimulation. After the user selects the Magic Generate Image, the progress of generation status is displayed on the right side of the canvas interface. The user engages in in-depth communication with the AI assistant through natural language, to achieve more precise demand transmission and creative collaboration.

The technical solution of the embodiment of the present disclosure improves the accuracy of intent recognition by comprehensively analyzing the material and user instruction; and dynamically provides content generation options based on the recognition result of the user intent, allowing the user to participate in key decisions through selection operations, thereby avoiding understanding deviations from the source, and ultimately improving the controllability of the generation process while improving the content generation efficiency and content quality.

In some embodiments, the user instruction includes a doodling instruction for the material on a canvas interface and/or a text instruction entered on a dialog interface.

Here, the canvas interface is a graphical interface allowing the user to directly visualize operations and edit materials. The doodling instruction is a freehand mark made by the user on the canvas for the specific material. For example, drawing a red circle on a clothing picture pointing to the collar indicates “hope to modify this area”; or marking “enlarge” next to a piece of text indicates “hope to enlarge the font”.

Here, the dialog interface is an area that typically exists in the form of a chat window and receives text instructions.

Here, the text instructions are natural language commands entered by the user in the dialog interface. For example, enter “Change the background to a starry sky” or “Mix these three images into a video”.

In some implementations, the system uses the event listening mechanism of the GUI to capture the user's doodle handwriting on the material in the canvas interface, bind and record the doodle handwriting with the material element being applied, and simultaneously capture the text string entered by the user in the dialog interface; and finally, the system integrates the instruction information in the two different modalities into unified input data that can be processed by the subsequent intent recognition module.

In this way, the means for the user to express creative intents are enriched by supporting two complementary instruction modes of doodle and text: the doodle instruction achieves intuitive and precise spatial location indication, while the text instruction provides the abstract and flexible semantic description capability. The combination of the two instructions enables the system to obtain more comprehensive and accurate user demand information, fundamentally overcomes the limitation of the single instruction mode (text only or doodle only), and lays the foundation for subsequently generating the content that highly meets the user expectation.

In some embodiments, after outputting at least one content generation option based on the generation intent and before generating the multimodal content, the method further includes: outputting a configuration interface in response to determining that supplementary information is required for the generation intent, to obtain the supplementary information input for the configuration interface. Here, the step of generating multimodal content based at least on the generation intent and the material in response to the user's selection of a target content generation option includes: generating the multimodal content based on the generation intent, the material and the supplementary information in response to the user's selection of the target content generation option. In other words, it is judged whether the generation intent needs the user to provide supplementary information; if so, one configuration interface is presented to the user to obtain the user's configuration input.

In the embodiment of the present disclosure, the supplementary information refers to information that the user needs to clarify or refine when the intent may be ambiguous or incomplete. For example, confirm the playback order of multiple images, or choose one generation style from multiple styles such as “realistic style” and “anime style”.

In the embodiment of the present disclosure, the configuration interface is an interactive interface presented by the system to the user for collecting the supplementary information, for example, a pop-up configuration card including an image drag-and-drop sorting area, a style selection button, etc.

In the embodiment of the present disclosure, the configuration input is the final decision parameter provided by the user through the configuration interface, for example, the image order list determined by the user, or the selected “ink painting style” option.

In some implementations, the system has a built-in intent analyzer that evaluates the complexity and clarity of the recognized generation intent based on preset rules (such as the number of materials, the ambiguity of the instruction, and the number of optional parameters); when determining that the intent needs to be further clarified, the system dynamically generates and renders a matching configuration interface (such as configuration card). This configuration interface provides necessary interactive components (such as sorter and selector), captures all interaction results of the user on this interface as a structured configuration input, and finally sends this input along with the initial generation intent and materials to the downstream content generation module.

In this way, the optimal balance is achieved between automated process and user control by introducing an intelligent and condition-triggered decision-making layer, which avoids unnecessary interactive interference when the intent is clear, ensures the efficiency of the basic process, and simplifies the operation complexity; and can also proactively guide the user to provide key decisions when the intent is ambiguous or there are multiple possibilities, improving the accuracy of the generated content, and fundamentally solving the problem of repeated trial and error caused by understanding deviations in the prior art.

In some embodiments, the supplementary information is determined to be required for the generation intent under at least one of following conditions: clarity of the generation intent is lower than a preset threshold; there are multiple materials and generation logic thereof depends on a specific arrangement order; combinations of material types contained in the user input are associated with different generation intents; or there are a plurality of optional styles or parameters associated with the generation intent.

In the embodiment of the present disclosure, the clarity of the generation intent is a deterministic measure of the user intent identified by the system. For example, if the user enters “optimize this image”, the clarity of the intent is low (the direction of optimization is unclear); if the user enters “increase the resolution of this image to 4K”, the clarity of the intent is high.

In the embodiment of the present disclosure, the preset threshold is a preset confidence threshold value to trigger the user confirmation process.

In the embodiment of the present disclosure, the generation logic depends on a specific arrangement order, meaning that the arrangement order of the materials directly affects the final generation result. For example, when generating a video from three images A, B, and C, the order A->B->C and the order C->B->A will tell completely different stories.

In the embodiment of the present disclosure, the combinations of material types are associated with different generation intents, meaning that multiple types of materials provided by the user may correspond to multiple interpretations. For example, if a user uploads both an image and a piece of text, this combination may be associated with an intent of “modifying the image based on the text” or may be associated with an intent of “generating a text description for the image”.

In the embodiment of the present disclosure, the optional styles or parameters are different visualization or execution modes to achieve the same generation intent. For example, for the “text-to-image” intent, the optional styles include “realistic”, “cartoon”, “ink painting”, etc. ; and the parameters may include “image ratio” and “number of images generated”.

In some implementations, the system matches the features of the current generation task (such as the semantic ambiguity of the user instruction, the number and type of materials, and the number of available style options) with preset triggering conditions in real time through a rule engine or lightweight classification model; if any condition is met, the user confirmation process is automatically triggered, and the corresponding configuration interface is dynamically generated and presented to collect the key decision information.

In this way, the accuracy and reliability of content generation are improved by introducing the multi-dimensional intelligent judgment mechanism. By evaluating the clarity of the generation intent, the system can effectively intercept ambiguous or low-confidence generation requests, prevent the low-quality output due to insufficient understanding from the source, and ensure the basic generation quality; for scenes with sequential dependence of multiple materials, the system can recognize and ensure the correct arrangement of materials with temporal or logical relationships, avoiding the core defect of illogical generated result due to disordered order; when the input contains a combination of multiple types of materials, the system can accurately recognize the semantic ambiguity therein and guide the user to clarify the primary and secondary relationships by actively asking questions, improving the accuracy of intent recognition. By offering a variety of optional styles and parameters, the system can precisely control the generation process based on the user's explicit choices, optimize the matching degree between the output content and the target scene, and thus improve the content quality.

In some embodiments, the configuration interface is displayed in the form of a configuration card, and a display position thereof is adaptively adjusted according to current operation interface context, where the operation interface context includes a full-screen canvas interface or an embedded dialog interface.

In this embodiment, the configuration card is a specific configuration interface presented in the form of a floating card, with the clear boundary and structured layout, for example, a pop-up User Interface (UI) component containing an image sorting area, a style selection button and a confirmation operation.

In this embodiment, the operation interface context is the main interaction environment in which the user is currently located. For example, the full-screen canvas interface is the main design area where the user is focused on editing, such as the full-screen mode for PPT editing. The embedded chat interface is a chat window attached to the side or bottom of the main interface, such as the expandable/collapseable AI assistant sidebar in design tools.

In this embodiment, the adaptive adjustment means that the system automatically changes the display logic and position of the configuration card according to the context.

In some implementations, the system judges the current active context environment in real time by monitoring the user interaction events and interface status; when the configuration card needs to be displayed, the system selects the corresponding display scheme from predefined layout strategies based on this context information: in the case of the full-screen canvas interface, calculating and locating an appropriate position on the canvas near the operated material; in the case of the embedded dialog interface, rendering this interface as a message bubble in the dialog flow, thereby achieving intelligent matching between the display position and the interaction scene.

In this way, the pain point that the traditional pop-up window is detached from the user's current task context is fundamentally solved by making the presentation position of the configuration card dynamically fit the user's operation scenario, which not only significantly reduces unnecessary mouse movements and line of sight jumps, but also improves the overall execution efficiency of complex content generation tasks and the smoothness of user experience by maintaining the continuity of the interactive context.

In some embodiments, the process of adjusting the display position adaptively according to the current operation interface context includes: in response to determining that the operation interface context is a dialog interface, presenting the configuration card on the dialog interface; or in response to determining that the operation interface context is a canvas interface, presenting the configuration card on the canvas interface close to the material selected by the user.

In the embodiment of the present disclosure, the material selected by the user is one or more target objects specified by the user on the canvas through the clicking or box selecting operation. For example, three images are highlighted and framed in blue on the canvas.

In some implementations, the system obtains the current focus state of the interface in real time through the context-aware module of the UI framework; when determining that the current focus is on the dialog interface, inserts the configuration card as a special system message at the end of the dialog flow for rendering; and when determining that the current focus is on the canvas interface, obtains the screen coordinates of the selected material by calculation, and renders the configuration card in a suitable area near the coordinates (such as the upper right or lower right of the material) using the absolute positioning method.

In this way, the precise alignment of the configuration card with the user attention is achieved by implementing differentiated layout strategies conforming to scene intuition in different operating scenarios, thereby improving the operation efficiency of complex tasks and the overall smoothness of the user experience.

In some embodiments, the intelligent agent provides the user with at least one of the following configuration functions through the configuration card: the function of sorting multiple materials by the dragging and dropping operation; the function of eliminating ambiguity of the user instruction by a selection button; or the function of selecting a content generation style or parameter through an option list. The method for generating multimodal content further includes: in response to receiving an input operation for the configuration card, the intelligent agent performs at least one of the following operations: adjusting an arrangement order of multiple materials according to the user's drag-and-drop instruction; eliminating semantic ambiguity in an original instruction by allowing the user to select an explicit option; or determining a specific style parameter for content generation based on the user's selection from a preset list.

In the embodiment of the present disclosure, the user is allowed to adjust the order of materials by the dragging and dropping operation. For example, the user drags and drops three images in a list of configuration cards, and arranges these images in the order of cover image, first content image and second content image to generate a short video.

In the embodiment of the present disclosure, the explicit option allows the user to clarify his ambiguous intent. For example, the user uploads both a landscape image and a poem, and the configuration card displays two selection buttons: “Match image with poem atmosphere” and “Generate image to match poem”. The user clicks on one of them to eliminate ambiguity.

In the embodiment of the present disclosure, the specific style parameters are generation attributes presented in a list form for selection by the user. For example, a drop-down list or button group containing options such as “realistic photography”, “cartoon illustration” and “watercolor style” is used to select the visual style for image generation.

In some implementations, the system generates internal components of the configuration card dynamically based on the result of the above-mentioned judgment condition: for a sequentially dependent task, rendering a draggable material list; for a task with ambiguous intent, generating a set of mutually exclusive selection buttons, where each button corresponds to a clear intent interpretation; for a style parameter selection task, retrieving selectable values from a predefined resource library, and rendering these values as an option list (such as a drop-down menu or button group). Ultimately, the system captures the structured configuration input by monitoring the user's interaction events on these components.

In this way, by integrating a variety of targeted interactive components into the unified configuration card, an efficient and accurate “intent calibration” hub is constructed. This hub concretizes the user's control at key decision points into executable interactive actions, and transforms vague user inputs into precise machine instructions, which not only reduces the generation failure rate caused by understanding deviations or information loss, but also gives the user a full sense of control so that the final generated content highly matches the user expectation in terms of logic and accuracy, thereby improving the overall reliability, usability and user satisfaction of the generated content.

In some embodiments, the reception of the user input is triggered by any one of the following operations: in response to performing a first operation by the user on a canvas interface, where the first operation includes a selection operation of at least one material, or a doodling operation of the material and a subsequent selection confirmation operation; or, in response to performing a second operation by the user on a dialog interface, where the second operation is inputting a text instruction.

In the embodiment of the present disclosure, the first operation is a physical action of the user interacting directly with the material on the canvas. For example, the user selects one or more elements such as images or text boxes by clicking or box selection with the mouse. For another example, the user first draws a circle on an image (doodling operation), and then clicks the “Magic Generate” button appearing in the upper right corner of the image (selecting the confirmation operation).

In the embodiment of the present disclosure, the second operation is the user's interactive action in the dialog interface. For example, the user enters “Help me turn this image into watercolor style” in the chat box and presses Enter.

In some implementations, the system captures the user's mouse click, box selection range or touch handwriting on the canvas interface through a graphics event monitor. When an operation meeting the preset condition (such as selecting one material, or triggering the generation button after doodling on material) is detected, this operation and the target material thereof are packaged into a generation request; meanwhile, the plain text instructions entered by the user are captured through the form submission event of the text input box on the dialog interface; and the system maintains a unified task trigger to receive and initialize requests from these two independent interactive channels.

In this way, by supporting two complementary triggering paradigms of direct canvas operation and dialog text instruction, a unified generation entry covering requirements from specific editing to abstract conception is constructed. This entry satisfies users'pursuit of efficient and precise operational intuition in visual editing scenarios, and also ensures the flexibility to express complex intents in free creation scenarios, thereby adapting to the natural working habits of users with different skill backgrounds in various application scenarios, and significantly improving the ease of use and application scope of the system.

In some embodiments, the step of analyzing the user input to determine the user's generation intent includes: matching a generation strategy from a predefined strategy library according to a type and quantity of the material in combination with semantics of the user instruction; where the generation strategy at least includes one of: text-to-image, text-to-video, image-to-image, multi-image-to-video, or mixed text-image editing.

In the embodiment of the present disclosure, the type and quantity of the material are basic attributes of the user-provided content. For example, the type includes, but is not limited to, image, video, text, audio, etc. The quantity includes, but is not limited to, a single image, a sequence of multiple images, a combination of image and text, etc.

In the embodiment of the present disclosure, the semantics of the user instruction is the deeper meaning expressed by the natural language input by the user. For example, the instruction “make image more vibrant” semantically refers to “color enhancement” and “contrast improvement”.

In the embodiment of the present disclosure, the predefined strategy library is a collection of built-in generation capabilities and rules of the system, for example, a database or configuration file containing processing logic of various generation scenarios.

In the embodiment of the present disclosure, the generation strategy is a specific processing scheme selected by the system. For example, text-to-image: generating a corresponding image based on the text “a cat in a suit”; text-to-video: generating a short video based on the text “process of sunrise”; image-to-image: performing style conversion, restoration or editing based on an original image; multi-image-to-video: combining multiple travel photos into a dynamic album; mixed text and image editing: adding artistic text to an image or modifying the text in an image.

In some implementations, the system analyzes the metadata (such as image size and video duration) of the material file and the text features of the user instruction simultaneously through a multimodal understanding engine, parses the semantics of the instruction using the natural language processing technology, identifies the material content features in combination with the computer vision technology, fuses these multi-dimensional information and then performs weighted matching in the predefined strategy library, and outputs the most suitable generation strategy identifier and the confidence score thereof.

In this way, the optimal generation path can be quickly and accurately located from a massive number of possibilities by comprehensively analyzing the material attributes and the deep semantics of the user instruction, thereby effectively solving the problem of unexpected generation results due to deviations in intent understanding in traditional solutions, and improving the accuracy of content generation.

In some embodiments, the step of generating multimodal content based at least on the generation intent and the material in response to the user's selection of a target content generation option includes: providing generation process feedback synchronously in a canvas interface and a dialog interface; where an output form on the canvas interface is displaying a generation placeholder with a loading animation at a target location; and an output form on the dialog interface is updating a status card of a generation status in real time.

In the embodiment of the present disclosure, the generation process feedback is real-time visual information about the task status provided by the system to the user during content generation. The generation placeholder is a temporary visual element reserved on the canvas to represent the content to be generated soon, for example, a gray rectangular box with loading animation with size and position consistent with those of the final generated image or video. The loading animation represents the dynamic visual effect of the system being processing a task, for example, a progress ring, a pulsating effect or a skeleton screen displayed on the placeholder.

In the embodiment of the present disclosure, the status card is a structured UI component that displays task progress information in the dialog interface, for example, a message bubble displaying text such as “Generating . . . 65%” or “Processing your video” along with a progress bar.

In some implementations, when confirming that the task has started to be executed, the system may broadcasts a state update event to all active interface components (canvas rendering engine and dialog interface manager); after receiving the event, the canvas interface may create and render a placeholder element with loading animation at the pre-calculated target position; meanwhile, the dialog interface may insert a new status card component into the message flow and establish a long connection with the background task status, so as to receive progress updates and refresh the displayed content in real time.

In this way, by providing complementary and context-adaptive visual feedback in different interface scenes, the spatial stability and layout predictability of the creative scene are maintained in the form of placeholder on the canvas interface while the traceable task progress timeline is constructed through the status card on the dialog interface, to jointly transform the “black box” state of the traditional generation process into the transparent, visible and perceptible continuous operation experience, effectively eliminate the sense of uncertainty and anxiety of the user in the waiting process, and significantly improve the trust level and collaboration efficiency of human-computer interaction.

In some embodiments, a size of the generation placeholder is set based on a pre-calculation of a size of the multimodal content. The size of the multimodal content is the physical size of the multimodal content that the system expects to output when presented on the canvas, for example, the display area of an image with pixels 1024×768 or a video with resolution of 1920×1080 and duration of 15 seconds on the canvas.

In the embodiment of the present disclosure, the pre-calculation is a size estimation process performed before the content is actually generated.

In some implementations, after receiving a generation task, the system quickly calculates the size occupied by the final result in the canvas coordinate system before the actual content generation begins through a built-in size calculation algorithm according to the task type (such as image generation, video composition), user-preset output parameters (such as resolution, aspect ratio) as well as the current scaling ratio and layout constraints of the canvas, and immediately applies this size to the generation placeholder to be rendered.

In this way, the page layout jumps and visual fragmentation caused by dynamic content insertion are fundamentally eliminated by pre-calculating and precisely reserving the visual occupied space completely consistent with the physical size of the multimodal content, which not only ensures the visual stability and professionalism of the creation interface, but also significantly improves the user's focus and operational continuity during the content generation process by establishing the accurate visual expectation, thereby improving the content generation efficiency.

In some embodiments, after the task of generating the multimodal content is completed, the method further includes: replacing the generation placeholder with the multimodal content on the canvas interface; and updating the generation status card to a result preview card for presenting the multimodal content on the dialog interface.

In the embodiment of the present disclosure, the result preview card is a special UI component for displaying the final generated result, for example, an interactive card containing a thumbnail, a download button and an operation option.

In some implementations, when the system receives a notification that the task is completed, the canvas interface will locate the corresponding generation placeholder and smoothly replace it with the multimodal content obtained from the storage service; and at the same time, the dialog interface will update the corresponding generation status card to a result preview card, which will load a thumbnail or preview link of the result and reconfigure the relevant interactive operation button.

In this way, the seamless fusion of the generated content with the creation environment is achieved on the canvas interface, ensuring the zero-disruption experience for the user workflow; and at the same time, an interactive result management center is established on the dialog interface to form a complete closed loop from process tracking to result application, thereby effectively solving the core pain point of disconnection between result delivery and usage scenario in traditional content generation tools, and improving the creation efficiency and operational smoothness.

In some embodiments, the result preview card is correlatively provided with at least one subsequent operation option, including at least one of: adding to canvas, regenerating, downloading or copying.

In the embodiment of the present disclosure, the subsequent operation option is the further processing function associated with the generated result.

In the embodiment of the present disclosure, adding to canvas means placing the generated result material into the canvas workspace. (Add to canvas) provides a seamless transition from the dialog interface to the canvas workspace, and the generated result can be directly put into the subsequent creative process without user manual import, thus improving the work continuity.

In the embodiment of the present disclosure, regeneration is to execute the generation task again based on the same parameters. (Regeneration) allows for rapid iterative optimization. When the user is not satisfied with the initial result, the user can obtain an alternative solution without re-entering instructions, thus improving the trial-and-error efficiency and result satisfaction.

In some implementations, when rendering the result preview card, the system simultaneously generates a set of operation button components matching the type of the current generation task, embeds these buttons at the bottom or side of the card in the form of horizontal layout or drop-down menu, and binds a corresponding event handling function to each button. When a user clicks, the corresponding service logic (for example, invoking the Application Programming Interface (API) of the canvas to add an element, resubmitting the generation task, invoking the download interface, or manipulating the clipboard) is triggered.

In this way, the high-frequency subsequent operations are aggregated into the result preview scene, creating the closed-loop experience of “generation-preview-application”, effectively solving the problems of scattered result usage paths and lengthy operation chains in traditional processes, achieving seamless connection of the creative process through “Add to Canvas”, providing the low-cost iterative optimization capability through “Regenerate” while covering the basic requirement for content export through “Download/Copy”, significantly reducing the user's operational cognitive load and the frequency of step jumps, and comprehensively improving the actual application efficiency after content generation.

In some embodiments, the step of generating multimodal content based at least on the generation intent and the material in response to the user's selection of a target content generation option includes: constructing a configuration task based on a task type defined by the target content generation option, the generation intent and the material; and invoking an intelligent agent to perform a content generation operation according to the configuration task to obtain the multimodal content.

In the embodiment of the present disclosure, the intelligent agent is a core software module responsible for coordinating and managing the lifecycle of the content generation task. The intelligent agent may be an independent and specialized content generation module, for example, a microservice dedicated to running the text-to-image large model, or a cloud function dedicated to video composition.

In the embodiment of the present disclosure, the configuration task is structured task definition data, which encapsulates all the necessary parameters required for content generation and is used to drive the intelligent agent to perform specific operations.

In some implementations, after the user confirms the generation option on the front end, the front end service sends a request to the task processing system; this system first registers with the task management service to obtain a unique task identifier, and immediately creates a record (pre-placement) with status of “waiting” for the task in the task processing queue; then the system assembles the generation option, generation intent and material information of the target content contained in the front-end request into a structured configuration task object; and finally, the system submits the configuration task to an independent intelligent agent via API call and begins monitoring the processing status.

In this way, the standardization and precision of the generation instruction are achieved by integrating the user-confirmed target option, generation intent and material into the structured configuration task, and then the content generation operation is performed by the intelligent agent according to the configuration task, improving the content generation efficiency and content quality.

In some embodiments, the step of invoking an intelligent agent to perform a content generation operation according to the configuration task includes: invoking at least two intelligent agents to execute multiple configuration tasks in parallel, where the configuration tasks executed in parallel include at least two different types of tasks among text-to-image, image-to-image, image processing, video generation or document generation.

In some implementations, after receiving the target content generation option, the system parses the task type feature contained in the option through a predefined routing rule or classification model, and then distributes the task request and context information thereof (such as generation intent, material, etc.) to the corresponding dedicated processing branches according to the parsing result. Each branch has its own independent parameter verification, resource allocation and task execution logic. For example, the text-to-image branch is dedicated to the process of text-to-image generation, the image-to-image branch is dedicated to the process of image-to-image conversion, and the video generation branch is dedicated to the process of video composition and editing.

In this way, the dynamic optimal allocation of system resources and efficient parallel processing of heterogeneous computing loads are achieved by scheduling multiple intelligent agents to execute at least two heterogeneous tasks such as text-to-image and image-to-image in parallel, which not only solves the problems of resource idleness and processing bottleneck under a single task queue, but also significantly improves the throughput efficiency of multimodal content generation and the overall system performance through specialized task routing.

In some embodiments, before invoking the intelligent agent to execute the configuration task, the method further includes: performing legality check on the task, where the legality check includes at least one of user identity check or traffic quota check. The legality check is the process of validating the compliance of the request before the task is executed. The user identity check is a check verifying user permissions, for example, verifying the validity of the user's API key, checking whether the user account is in a normal state, or confirming whether the user has the right to use the specific generation function.

In some implementations, the system verifies the submitter's identity credential and account status by invoking the user service interface, and simultaneously queries the quota management system to check the user's remaining usage quota. The verification process is carried out in a real-time synchronous manner. If any check fails, the process will be terminated immediately and the clear error information will be returned.

In this way, the comprehensive service guarantee system is constructed by embedding the legality check mechanism into the critical path of task execution, which not only maintains the system's security boundary through identity check, but also ensures the rationality and sustainability of resource allocation through quota control.

In some embodiments, before invoking the intelligent agent to execute the configuration task, the method further includes: persistently storing the material and configuration task information to a storage center. The storage center is a unified service or component responsible for data persistence in the system, for example, a cloud storage service, a distributed database, or a file server cluster.

In some implementations, after completing the configuration task construction and legality check, the system treats the configuration task information and associated material file (or its unique index in the content library) as a complete data record and writes them into the specified persistent storage device in the form of atomic operation by invoking the API interface provided by the storage center, and ensures that the record contains key metadata such as task identifier (ID) and timestamp.

In this way, the persistent storage step establishes a reliable data snapshot and recovery base point for task execution, ensures that the key information and context of the task will not be lost even if a system interruption or service anomaly occurs during subsequent generation, thus providing a solid data foundation for realizing task breakpoint resume, status review and post audit.

In some embodiments, the step of invoking an intelligent agent to perform a content generation operation according to the configuration task includes: obtaining a task status of the intelligent agent performing the content generation operation; generating status update information based on the task status, where the status update information at least includes a task progress percentage and a result identifier indicating task success or failure; and outputting the status update information through an interactive interface.

In the embodiment of the present disclosure, the task status is the stage identifier of the generation task in the life cycle, for example, “being processed”, “success”, “failure”. The status update information is a structured message carrying task status data, for example, “Be generating image . . . ” or “Generating . . . 25%”.

In some implementations, after submitting the configuration task, the system starts a status listener, which continuously obtains the latest status of the task by polling the status query interface of the intelligent agent or subscribing to the status change events published by the intelligent agent; whenever a status change is detected, the system converts the original status data into the structured update information containing the progress percentage and result identifier according to a predefined mapping rule, and sends the information to the front-end interactive interface in real time using the push technology; and after receiving the information, the front end calls the corresponding UI update function to dynamically adjust the visual elements displayed to the user.

In this way, the internal task status of the system is transformed into the structured information containing the progress quantification indicator and result identifier by establishing the standardized status data acquisition and feedback link, realizing the full-link observability of the generation process, providing data support for task scheduling optimization, anomaly diagnosis and dynamic resource allocation, and thus significantly improving the controllability and stability of system operation.

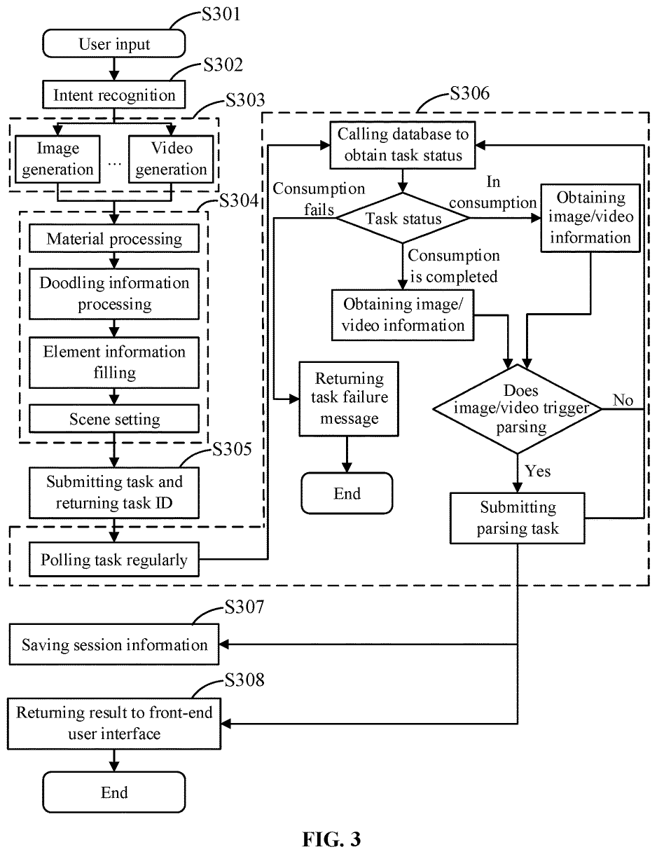

FIG. 3 shows a schematic diagram of a triggering and processing flow of a multimodal content generation task.
S301: detecting a user input.
S302: performing intent recognition. The system will perform intent recognition on the user's click operation.
S303: performing task diversion according to the recognized intent. For example, tasks are diverted to different processing channels such as “Magic Image” or “Magic Video”.
S304: task parameter construction. Here, S304 may include S304a, S304b, S304c and S304d.
S304a: material processing. Specifically, the system invokes the content selection service to obtain the Uniform Resource Locator (URL) of the original image according to an attachment list passed in from the front end, and fills this URL into the field file_url.
S304b: doodling information processing. Specifically, the system invokes the object storage service to obtain the screenshot URL of canvas doodling according to the screenshot object passed in from the front end, and fills this URL into the field image_url.
S304c: element information filling. Specifically, the system fills all element information into the extended field.
S304d: scene setting. Specifically, the system sets the scene type (scence_type) to “wk”, and sets the scene to “image editing” or “image-to-video” according to the task type.
S305: submitting a task and returning a task ID. After the parameter construction is completed, the system submits an image or video generation task and obtains a unique task ID.
S306: task status tracking. The system continuously polls the task center using a timer (ticker) to query the task status. Branch processing is performed based on the polled task status. If the task fails, the process will proceed to branch processing of “message failure”. If the task is completed, the generated image or video information is retrieved from storage, then the result is returned to the front-end user interface via a message frame (WriteMessageFrame), the information of this session is saved, and the process ends. It should be noted that before the result is returned to the front-end user interface and the information of this session is saved, there is a judgment node of “whether the user/video triggers parsing?” in the process. A parsing task needs to be submitted for further analysis under certain conditions.
S307: saving the session information.
S308: returning the result to the front-end user interface.

This process ensures the automation and controllability of the entire link from user intent recognition, task parameter preparation, background asynchronous processing to final result return.

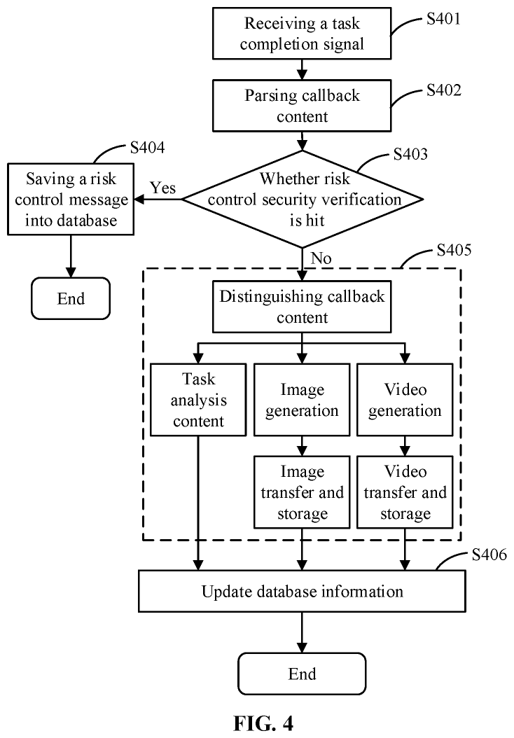

FIG. 4 shows a schematic diagram of an asynchronous callback and result processing flow of the generation task. After completing the task, the intelligent agent notifies the system of the task status and result through a dedicated callback interface.
S401: receiving a task completion signal.
S402: parsing the content in a callback request and extracting the key information, such as task ID (taskId), task status (status), temporary access address of the generated result, or error information.
S403: performing risk control security verification on the parsed callback data. If the risk control is hit, execute S404; if the risk control is not hit, execute S405.
S404: saving the risk control violation information of this task into the database, and ending the process directly.
S405: distinguishing the final content type of the task according to the callback data. The task is diverted to three processing branches: task analysis content: processing the generated metadata or text analysis result; image generation: processing an image-type generation result; and video generation: processing a video-type generation result.
S406: updating the final result of the task (including a new address after transfer) into the database. For the image-type and video-type results, the system will perform the transfer operation. That is, the result file returned by the intelligent agent and stored in a temporary location is migrated to the stable storage center of the service party, and a new and persistent access address is obtained.

This process ensures that the result of the generation task can be received and processed securely, reliably and asynchronously, and guarantees the content compliance through risk control verification and the long-term availability of the result through resource transfer.

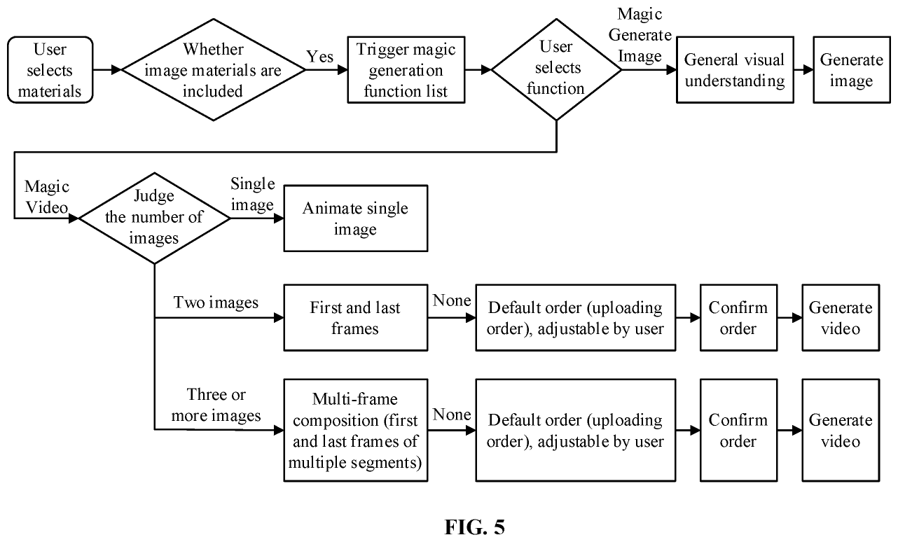

FIG. 5 shows a schematic diagram of a triggering and execution process of an intelligent generation function based on image materials. The user selects one or more materials on the canvas. The system first judges whether the materials selected by the user include image materials. If not, the magic generation function will not be triggered. If so, the system will trigger and display a list of available magic generation functions to the user, allowing the user to select a specific function from the list. If the user selects “Magic Generate Image”, the system will invoke AI services such as general visual understanding to perform in-depth analysis and understanding of the image, and execute the image generation task based on the understanding result, to output a new image. If the user selects “Magic Video”, the system first judges the number of images selected and then proceeds to different sub-processes based on the number. If there is a single image, the single image animation function is executed to convert the static image into a dynamic video. If there are two images, the video composition function of first and last frames is executed to generate a transition video with the two images as the beginning and ending of the video. If there are three or more images, the multi-frame composition function (which can be understood as splicing first and last frames of multiple segments together) is executed to generate a more complex video. For multiple (two or more) images, the system may provide a default order (such as uploading order) and allow the user to manually adjust the order of the images. After the user confirms the order, the system will finally execute the video generation task.

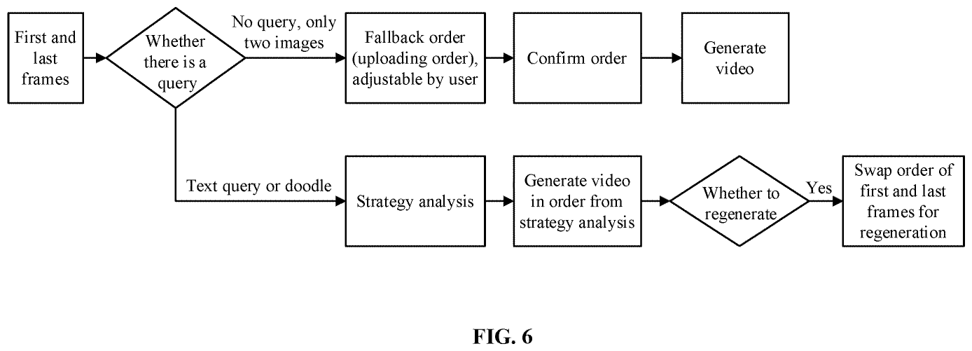

FIG. 6 shows a schematic diagram of a video generation and intelligent optimization process of first and last frames. The system confirms that the video is generated using the first and last frame mode, with two images as input. The system first judges whether there is any additional instruction (query) or doodle provided by the user. If there is no query/doodle, a default completion order (such as the image uploading order) is used as the video frame sequence, but the user can still manually adjust this order. If there is a query/doodle, the system enters the strategy analysis phase and deeply analyzes the semantics of the user's instruction to determine a more logical or user-expected order of first and last frames. Regardless of the default order or the order derived from analysis, the system will present the order scheme to the user for final confirmation. After the user confirms, the system generates a video according to the (default or analysis-derived) order. After the video is generated, the system will ask the user whether to regenerate. If the user selects “yes”, the system performs a critical optimization operation: swapping the order of the first and last frames for regeneration. If the user selects “no”, the process ends and the video generation task is completed.

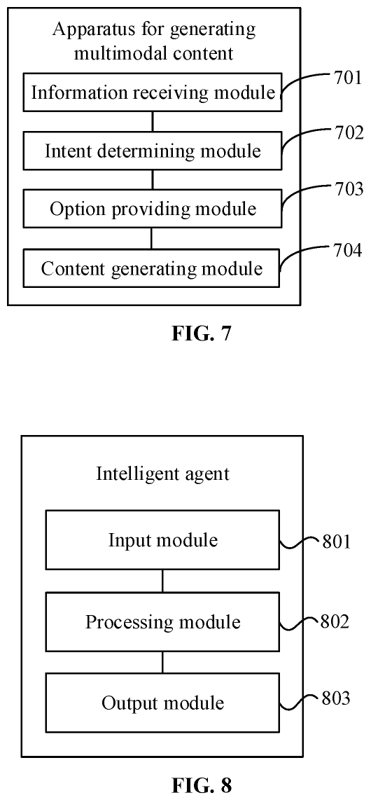

An embodiment of the present disclosure provides an apparatus for generating multimodal content. As shown in FIG. 7, the apparatus may include: an information receiving module 701 configured to receive a user input, where the user input includes material uploaded by a user and a user instruction; an intent determining module 702 configured to analyze the user input to determine the user's generation intent; an option providing module 703 configured to output at least one content generation option based on the generation intent; and a content generating module 704 configured to generate multimodal content based at least on the generation intent and the material in response to the user's selection of a target content generation option.

In some embodiments, the user instruction includes a doodling instruction for the material on a canvas interface and/or a text instruction entered on a dialog interface.

In some embodiments, the apparatus further includes an intent judgment module 705 (not shown in FIG. 7) configured to: after the option providing module 703 outputs at least one content generation option and before the content generation module 704 generates multimodal content, output a configuration interface in response to determining that supplementary information is required for the generation intent, to obtain the supplementary information input for the configuration interface; where the content generation module 704 is further configured to generate the multimodal content based on the generation intent, the material and the supplementary information in response to the user's selection of the target content generation option.

In some embodiments, the condition on which the intent judgment module 705 makes judgment includes at least one of: clarity of the generation intent is lower than a preset threshold; there are multiple materials and generation logic thereof depends on a specific arrangement order; combinations of material types contained in the user input are associated with different generation intents; or there are a plurality of optional styles or parameters associated with the generation intent.

In some embodiments, the configuration interface provided by a configuration interface module 706 is displayed in the form of a configuration card, and a display position thereof is adaptively adjusted according to current operation interface context, where the operation interface context includes a full-screen canvas interface or an embedded dialog interface.

In some embodiments, the configuration interface module 706 is further configured to: in response to determining that the operation interface context is a dialog interface, present the configuration card on the dialog interface; or in response to determining that the operation interface context is a canvas interface, present the configuration card on the canvas interface close to the material selected by the user.

In some embodiments, the content generation module 704 is further configured to: in response to receiving an input operation for the configuration card, perform at least one of following operations: adjusting an arrangement order of multiple materials according to the user's drag-and-drop instruction; eliminating semantic ambiguity in an original instruction by allowing the user to select an explicit option; or determining a specific style parameter for content generation based on the user's selection from a preset list.

In some embodiments, the receiving operation of the information receiving module 701 is triggered by any one of following operations: in response to performing a first operation by the user on a canvas interface, where the first operation includes a selection operation of at least one material, or a doodling operation of the material and a subsequent selection confirmation operation; or, in response to performing a second operation by the user on a dialog interface, where the second operation is inputting a text instruction.

In some embodiments, the intent determining module 702 is further configured to: match a generation strategy from a predefined strategy library according to a type and quantity of the material in combination with semantics of the user instruction; where the generation strategy at least includes one of: text-to-image, text-to-video, image-to-image, multi-image-to-video, or mixed text-image editing.

In some embodiments, the apparatus further includes a feedback module 707 (not shown in FIG. 7) configured to: provide generation process feedback synchronously in a canvas interface and a dialog interface during the process of generating the multimodal content; where an output form on the canvas interface is displaying a generation placeholder with a loading animation at a target location; and an output form on the dialog interface is updating a status card of a generation status in real time.

In some embodiments, in the feedback module 707, a size of the generation placeholder is set based on a pre-calculation of a size of the multimodal content.

In some embodiments, the feedback module 707 is further configured to, upon completion of the task of generating the multimodal content, replace the generation placeholder with the multimodal content on the canvas interface; and update the generation status card to a result preview card for presenting the multimodal content on the dialog interface.

In some embodiments, the result preview card is correlatively provided with at least one subsequent operation option, including at least one of: adding to canvas, regenerating, downloading or copying.

In some embodiments, the content generation module 704 is configured to: construct a configuration task based on a task type defined by the target content generation option, the generation intent and the material; and invoke an intelligent agent to perform a content generation operation according to the configuration task to obtain the multimodal content.

In some embodiments, the content generation module 704 is further configured to: invoke at least two intelligent agents to execute multiple configuration tasks in parallel, where the configuration tasks executed in parallel include at least two different types of tasks among text-to-image, image-to-image, image processing, video generation or document generation.

In some embodiments, the content generation module 704 is further configured to: obtain a task status of the intelligent agent performing the content generation operation; generate status update information based on the task status, where the status update information at least includes a task progress percentage and a result identifier indicating task success or failure; and output the status update information through an interactive interface.

For the description of specific functions and examples of the modules and sub-modules of the apparatus of the embodiment of the present disclosure, reference may be made to the relevant description of the corresponding steps in the above-mentioned method embodiments, and details are not repeated here.

The apparatus for generating multimodal content in the embodiment of the present disclosure can improve the accuracy of intent recognition, and increase the controllability, generation efficiency and content accuracy of the generation process.

An embodiment of the present disclosure provides an intelligent agent, as shown in FIG. 8, including: an input module 801 configured to receive input information; a processing module 802 configured to perform steps in the method for generating multimodal content based on the input information received by the input module 801, to determine a target task and execute the target task to obtain output information; and an output module 803 configured to output the output information obtained by the processing module 802. In some embodiments, the processing module 802 is configured to invoke an external content generation API or model service when executing the target task. In some embodiments, the intelligent agent is encapsulated as a separately deployable software service, plugin or cloud API.

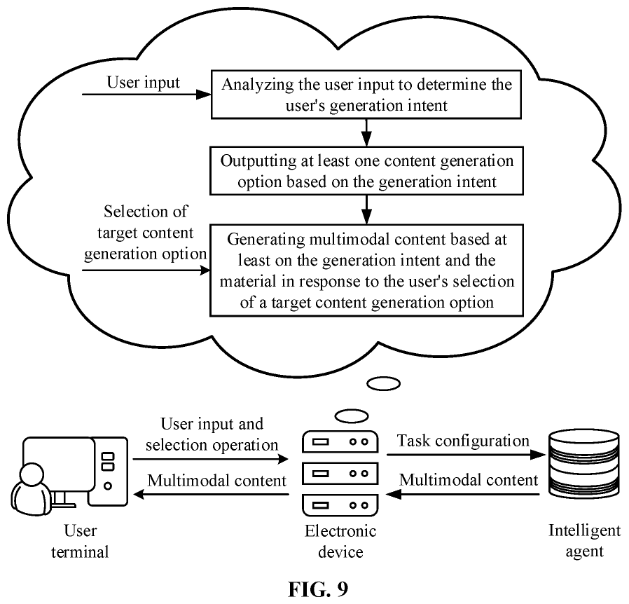

An embodiment of the present disclosure provides a schematic diagram of a scenario of the method for generating multimodal content, as shown in FIG. 9.

As mentioned above, the method for generating multimodal content provided in the embodiment of the present disclosure is applied to an electronic device. The electronic device is intended to represent various forms of digital computers, such as a laptop, a desktop, a workstation, a personal digital assistant, a server, a blade server, a mainframe computer, and other suitable computers.

Specifically, the electronic device may perform the following operations: receiving a user input, where the user input includes material uploaded by a user and a user instruction; analyzing the user input to determine the user's generation intent; outputting at least one content generation option based on the generation intent; and generating multimodal content based at least on the generation intent and the material in response to the user's selection of a target content generation option.

It should be understood that the scenario diagram shown in FIG. 9 is only illustrative and not restrictive, those skilled in the art can make various obvious changes and/or replacements based on the example of FIG. 9, and the obtained technical solutions still belong to the disclosure scope of the embodiments of the present disclosure.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

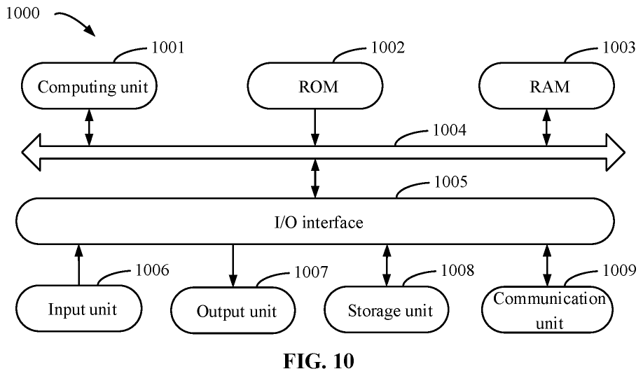

FIG. 10 shows a schematic block diagram of an exemplary electronic device 900 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 10, the device 1000 includes a computing unit 1001 that may perform various appropriate actions and processes according to a computer program stored in a Read-Only Memory (ROM) 1002 or a computer program loaded from a storage unit 1008 into a Random Access Memory (RAM) 1003. Various programs and data required for an operation of device 1000 may also be stored in the RAM 1003. The computing unit 1001, the ROM 1002 and the RAM 1003 are connected to each other through a bus 1004. The Input/Output (I/O) interface 1005 is also connected to the bus 1004.

A plurality of components in the device 1000 are connected to the I/O interface 1005, and include an input unit 1006 such as a keyboard, a mouse, or the like; an output unit 1007 such as various types of displays, speakers, or the like; the storage unit 1008 such as a magnetic disk, an optical disk, or the like; and a communication unit 1009 such as a network card, a modem, a wireless communication transceiver, or the like. The communication unit 1009 allows the device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1001 performs various methods and processes described above, such as the method for generating multimodal content. For example, in some implementations, the method for generating multimodal content may be implemented as a computer software program tangibly contained in a computer-readable medium, such as the storage unit 1008. In some implementations, a part or all of the computer program may be loaded and/or installed on the device 1000 via the ROM 1002 and/or the communication unit 1009. When the computer program is loaded into the RAM 1003 and executed by the computing unit 1001, one or more steps of the method for generating multimodal content described above may be performed. Alternatively, in other implementations, the computing unit 1001 may be configured to perform the method for generating multimodal content by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a random access memory, a read-only memory, an Erasable Programmable Read-Only Memory (EPROM), a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display device (e.g., a Cathode Ray Tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including components, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of such components, middleware components or front-end components. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for generating multimodal content, comprising:
receiving a user input, wherein the user input comprises material uploaded by a user and a user instruction;
analyzing the user input to determine the user's generation intent;
outputting at least one content generation option based on the generation intent; and
generating multimodal content based at least on the generation intent and the material in response to the user's selection of a target content generation option.

2. The method of claim 1, wherein the user instruction comprises a doodling instruction for the material on a canvas interface and/or a text instruction entered on a dialog interface.

3. The method of claim 1, wherein, after the outputting of the at least one content generation option based on the generation intent and before the generating of the multimodal content, the method further comprises:
outputting a configuration interface in response to determining that supplementary information is required for the generation intent, to obtain the supplementary information input for the configuration interface;
the generating of the multimodal content based at least on the generation intent and the material in response to the user's selection of the target content generation option, comprises:
generating the multimodal content based on the generation intent, the material and the supplementary information in response to the user's selection of the target content generation option.

4. The method of claim 3, wherein the supplementary information is determined to be required for the generation intent under at least one of following conditions:
clarity of the generation intent is lower than a preset threshold;
there are multiple materials and generation logic thereof depends on a specific arrangement order;
combinations of material types contained in the user input are associated with different generation intents; or
there are a plurality of optional styles or parameters associated with the generation intent.

5. The method of claim 3, wherein the configuration interface is displayed in the form of a configuration card, and a display position thereof is adaptively adjusted according to current operation interface context, wherein the operation interface context comprises a full-screen canvas interface or an embedded dialog interface.

6. The method of claim 5, wherein the adjusting of the display position adaptively according to the current operation interface context, comprises:
in response to determining that the operation interface context is a dialog interface, presenting the configuration card on the dialog interface; or
in response to determining that the operation interface context is a canvas interface, presenting the configuration card on the canvas interface close to the material selected by the user.

7. The method of claim 5, further comprising:
in response to receiving an input operation for the configuration card, performing at least one of following operations:
adjusting an arrangement order of multiple materials according to the user's drag-and-drop instruction;
eliminating semantic ambiguity in an original instruction by allowing the user to select an explicit option; or
determining a specific style parameter for content generation based on the user's selection from a preset list.

8. The method of claim 1, wherein reception of the user input is triggered by any one of following operations:
in response to performing a first operation by the user on a canvas interface, wherein the first operation comprises a selection operation of at least one material, or a doodling operation of the material and a subsequent selection confirmation operation; or
in response to performing a second operation by the user on a dialog interface, wherein the second operation is inputting a text instruction.

9. The method of claim 1, wherein the analyzing of the user input to determine the user's generation intent, comprises:
matching a generation strategy from a predefined strategy library according to a type and quantity of the material in combination with semantics of the user instruction;
wherein the generation strategy at least comprises one of: text-to-image, text-to-video, image-to-image, multi-image-to-video, or mixed text-image editing.

10. The method of claim 1, wherein the generating of the multimodal content based at least on the generation intent and the material in response to the user's selection of the target content generation option, comprises:
outputting generation process feedback synchronously in a canvas interface and a dialog interface;
wherein an output form on the canvas interface is displaying a generation placeholder with a loading animation at a target location; and
an output form on the dialog interface is updating a status card of a generation status in real time.

11. The method of claim 10, wherein a size of the generation placeholder is set based on a pre-calculation of a size of the multimodal content.

12. The method of claim 10, wherein after the generating of the multimodal content, the method further comprises:
replacing the generation placeholder with the multimodal content on the canvas interface; and
updating the generation status card to a result preview card for presenting the multimodal content on the dialog interface.

13. The method of claim 12, wherein the result preview card comprises at least one subsequent operation option, comprising at least one of: adding to canvas, regenerating, downloading or copying.

14. The method of claim 1, wherein the generating of the multimodal content based at least on the generation intent and the material in response to the user's selection of the target content generation option, comprises:
constructing a configuration task based on a task type defined by the target content generation option, the generation intent and the material; and
invoking an intelligent agent to perform a content generation operation according to the configuration task to obtain the multimodal content.

15. The method of claim 14, wherein the invoking of the intelligent agent to perform the content generation operation according to the configuration task, comprises:
invoking at least two intelligent agents to execute multiple configuration tasks in parallel, wherein the configuration tasks executed in parallel comprise at least two different types of tasks among text-to-image, image-to-image, image processing, video generation or document generation.

16. The method of claim 14, wherein the invoking of the intelligent agent to perform the content generation operation according to the configuration task, comprises:
obtaining a task status of the intelligent agent performing the content generation operation;
generating status update information based on the task status, wherein the status update information at least comprises a task progress percentage and a result identifier indicating task success or failure; and
outputting the status update information through an interactive interface.

17. An electronic device, comprising:
at least one processor; and
a memory connected in communication with the at least one processor;
wherein the memory stores an instruction executable by the at least one processor, and the instruction is executed by the at least one processor to enable the at least one processor to execute:
receiving a user input, wherein the user input comprises material uploaded by a user and a user instruction;
analyzing the user input to determine the user's generation intent;
outputting at least one content generation option based on the generation intent; and
generating multimodal content based at least on the generation intent and the material in response to the user's selection of a target content generation option.

18. The electronic device of claim 17, wherein the user instruction comprises a doodling instruction for the material on a canvas interface and/or a text instruction entered on a dialog interface.

19. A non-transitory computer-readable storage medium storing a computer instruction thereon, wherein the computer instruction is used to cause a computer to execute:
receiving a user input, wherein the user input comprises material uploaded by a user and a user instruction;
analyzing the user input to determine the user's generation intent;
outputting at least one content generation option based on the generation intent; and
generating multimodal content based at least on the generation intent and the material in response to the user's selection of a target content generation option.

20. The non-transitory computer-readable storage medium of claim 19, wherein the user instruction comprises a doodling instruction for the material on a canvas interface and/or a text instruction entered on a dialog interface.
